(19) United States
(12) Patent Application Publication
(10) Pub. No.: US 2009/0121488 A1
(43) Pub. Date: May 14, 2009

(54) Electric power generation system driven by solar flux and geocooling

(76) Inventors: Mohinder Singh Bhatti, Amherst, NY (US); Mingyu Wang, Amherst, NY (US); Shrikant Mukund Joshi, Williamsville, NY (US)

Correspondence Address: DELPHI TECHNOLOGIES, INC., M/C 480-410-202, PO BOX 5052, TROY, MI, 48007, US

(21) Appl. No.: 11/983,362

(22) Filed: Nov. 8, 2007

(51) Int. Cl. H02P 9/04; F24J 3/08; F25B 27/00; F25D 15/00

(52) U.S. Cl. 290/54; 165/45; 62/235.1; 62/260

(57) ABSTRACT

A system for generating electric power by utilizing solar heat flux. The system comprises a heating sub system and a cooling loop. The cooling loop circulates a coolant through a heat exchanger with an expanded second refrigerant which has been heated by the heating sub system thereby heating the coolant. The cooling loop includes a pipe buried in the ground at depth, D. A soil surrounds the length, L, of the pipe and a wrapping material defines and maintains a radial soil annulus width, δₛ, extending radially from the pipe to an outer periphery at a peripheral radius, r_{∞}, measured radially from its axis, A. The radial soil annulus width, δₛ, can be maintained at

$$\frac{{k}_{s}}{{h}_{s}} - {r}_{o} .$$

The length, L, of the pipe can be equal to

$$\frac{{mc}_{p}}{2 π} \{ \frac{0.5469}{{k}_{f}} + \frac{1}{{k}_{p}} ln ( \frac{{r}_{o}}{{r}_{i}} ) + \frac{1}{{k}_{s}} [ 1 + ln ( \frac{{r}_{∞}}{{r}_{o}} ) ] \}$$

wherein

$${r}_{∞} = \frac{{k}_{s}}{{h}_{s}} .$$

The depth, D, can be equal to rᵤ(\sqrt{α²−α+1}−α) wherein

$$α = exp [ \frac{2 π {k}_{p} L}{{mc}_{p}} - ln ( \frac{{r}_{o}}{{r}_{i}} ) ] .$$

### BACKGROUND OF THE INVENTION

1. Field of the Invention

The present invention relates to a system for generating electric power that requires a year round geothermal heat sink.

2. Description of the Prior Art

Electric power can be generated by utilizing the solar heat flux. One known cycle employed for generating electric power in this manner is the Rankine cycle. The four essential components of which are a pump, a heat source, a turbine, and a condenser. A fifth component, external to the cycle, is a generator, which uses the work output of the turbine to generate electric power.

In the Rankine cycle, power is generated by alternatively vaporizing and condensing a working fluid, which is commonly water. The fluid is confined to a closed loop and is used over and over again as it changes state from liquid to vapor and back to liquid.

It is known to provide a heating sub system (heat source) disposed above the ground for generating thermal energy and for circulating a fluid to convey thermal energy generated by the heating sub system. It is also known to combine the heating sub system with the turbine, the generator, and a cooling loop (condenser) for circulating a coolant having a thermal conductivity, k_{f}, and an isobaric specific heat, cₚ, therethrough at a mass flow rate, m, and for removing the thermal energy from the fluid.

The cooling loop can include a pipe made of a material having a thermal conductivity, kₚ, and having an axis, A, a length, L, and a circular cross section with an outside radius, rₒ, and an inside radius, rᵢ, for dissipating thermal energy into the ground. It is known to dispose the pipe in a horizontal orientation buried in the ground at depth, D, and to surround the length of the pipe with a soil having a thermal conductivity, kₛ. The soil has air vapor and water vapor mixed therein and the air vapor and the water vapor combining to define a soil heat transfer coefficient, hₛ, that is specific to the soil. It is also known for the pipe to be made of a material having a thermal conductivity, kₚ, less than the thermal conductivity, kₛ, of the soil.

A similar system is disclosed in U.S. Pat. No. 5,634,515 to Lambert, which teaches a geothermal heat transfer system comprising a plurality of heat exchange loops placed in the ground.

### SUMMARY OF THE INVENTION AND ADVANTAGES

The invention provides such a system including a wrapping material wrapped around the soil surrounding the length L of the pipe for defining and maintaining a radial soil annulus having a width, δₛ, around the pipe extending radially from the pipe to an outer periphery at a peripheral radius, r_{∞}, measured radially from the axis (A).

By utilizing the wrapping material to provide a consistent radial soil annulus width, δₛ, around the pipe along the length, L, of the pipe, heat transfer along the length, L, of the pipe will therefore be consistent. Further, the consistent radial soil annulus width, δₛ, can be optimized to provide for maximum heat transfer from the pipe into the soil.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a schematic drawing of a variation of the invention having a heating loop and a power generating loop showing flow of refrigerants and flow of coolant;

FIG. 2 is a schematic drawing of a variation of the invention having a heating loop showing flow of refrigerant and coolant;

FIG. 3 is a cross sectional view of a pipe having a circular cross section; and

FIG. 4 is a cross sectional view of a pipe having a star shaped cross section.

### DETAILED DESCRIPTION OF THE INVENTION

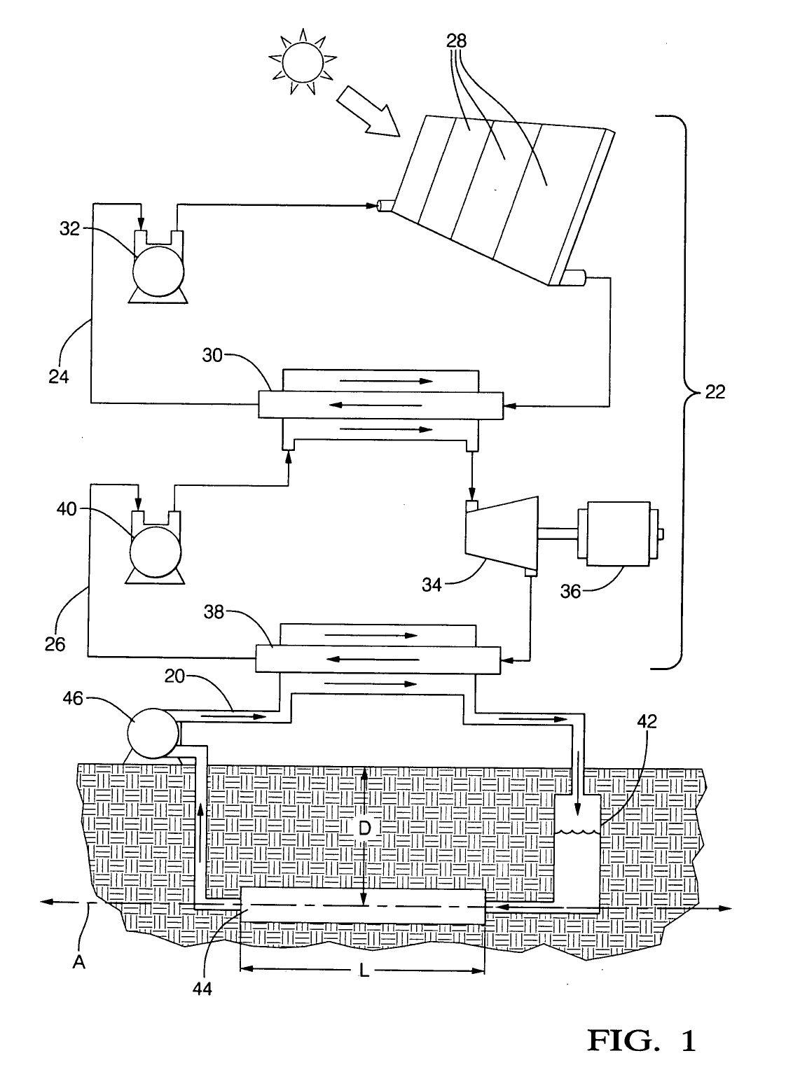

The invention relates to any system for generating power that requires a year round geothermal heat sink. Referring to the Figures, a variation of a system for generating electric power is generally shown in FIG. 1. The system comprises a cooling loop 20 and a heating sub system 22, which heating sub system 22 has a heating loop 24 and a power generating loop 26.

The heating loop 24 circulates a first refrigerant therearound and includes a plurality of solar collectors 28, a first heat exchanger 30, and a first refrigerant pump 32. The solar collectors 28 collect thermal energy generated by the sun. The first refrigerant passes through the solar collectors 28 and absorbs the thermal energy. As a result, the thermal energy evaporates the first refrigerant in liquid form into a vapor form of the first refrigerant. At this point, the vapor form of the first refrigerant has a first high pressure. As an example, the first refrigerant can be water.

The first heat exchanger 30 is in communication with the solar collectors 28 and removes thermal energy from the vapor form of the first refrigerant from the solar collectors 28. In doing so, the vapor form of the first refrigerant is condensed thereby producing the first refrigerant in liquid form, which is then pumped back to the solar collectors 28 via the first refrigerant pump 32 to complete the heating loop 24.

The power generating loop 26 circulates a second refrigerant through the first heat exchanger 30 in a cross current fashion with and in heat transfer relationship to the vapor form of the first refrigerant. As a result, thermal energy from the vapor form of the first refrigerant is transferred to the liquid form of the second refrigerant thereby vaporizing the second refrigerant, which produces a vapor form of the second refrigerant. At this point, the vapor form of the second refrigerant has a second high pressure. As an example, the second refrigerant can be R-134a.

The power generating loop 26 includes a turbine 34, a generator 36, a second heat exchanger 38, and a second refrigerant pump 40. The turbine 34 receives and expands the second high pressure vapor form of the second refrigerant. In doing so, mechanical work is produced. A generator 36 is coupled to the turbine 34 for generating electrical power from the mechanical work produced by the turbine 34.

The second heat exchanger 38 receives the expanded second refrigerant from the turbine 34 and removes thermal energy therefrom. In doing so, the expanded second refrigerant is condensed thereby producing the second refrigerant in liquid form, which is then pumped back to the first heat exchanger 30 via the second refrigerant pump 40 to complete the power generating loop 26.

The cooling loop 20 circulates a coolant, in liquid form, through the second heat exchanger 38 in a cross current fashion with and in heat transfer relationship to the vapor form of the expanded second refrigerant. As a result, thermal energy from the expanded second refrigerant is transferred to the coolant thereby heating the coolant, which produces heated coolant in liquid form. The coolant has thermal conductivity k_{f} and an isobaric specific heat cₚ. The coolant is circulated at a mass flow rate m.

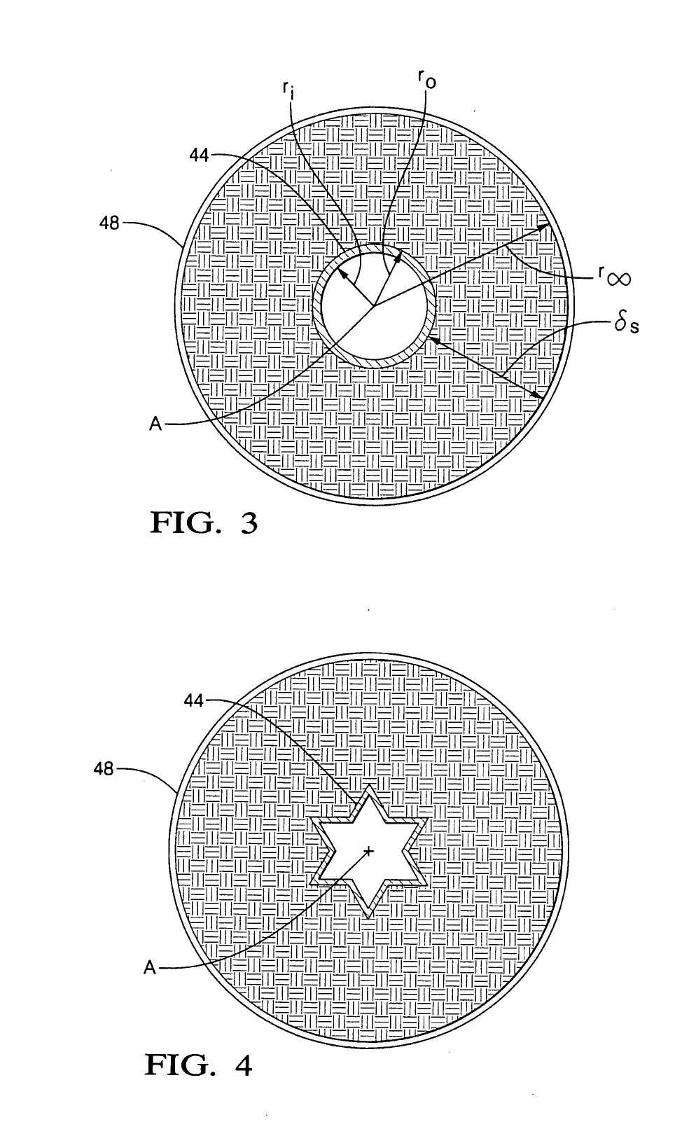

The cooling loop 20 includes a plenum 42, a pipe 44, and a coolant pump 46. The plenum 42 receives and stores the heated coolant from the second heat exchanger 38. The pipe 44 has an axis A, a length L, and a circular cross section with an outside radius rₒ and an inside radius rᵢ as shown in FIG. 3. The outside radius rₒ is measured radially from the axis A to the outer edge of the pipe 44 and the inside radius rᵢ is measured radially from the axis A to the inner edge of the pipe 44. The outside radius rₒ and the inside radius rᵢ differ by the thickness of the pipe 44. As the heated coolant flows through the pipe 44, thermal energy is removed from the heated coolant and dissipated into the ground. In doing so, the coolant is cooled thereby producing cooled coolant in liquid form, which is then pumped back to the second heat exchanger 38 via coolant pump 46 to complete the cooling loop 20.

The pipe 44 is made of a material having a thermal conductivity kₚ and is disposed in a horizontal orientation buried in the ground at depth D. As an example, the pipe 44 can be made of polyvinyl chloride (PVC).

A soil surrounds the length L of the pipe 44. The soil has a thermal conductivity kₛ and a radial soil annulus that has a width δₛ, that extends radially from the pipe 44 to an outer periphery at a peripheral radius r_{∞} measured radially from the axis A, as shown in FIG. 3. The heat dissipation rate from the coolant to the soil surrounding the pipe 44 will be high if the thermal conductivity kₛ of the soil is greater than or equal to the thermal conductivity kₚ of the material of the pipe 44. As an example, a PVC pipe 44 with thermal conductivity kₚ lower than the thermal conductivity kₛ of the soil will dissipate heat more effectively than and iron pipe 44 with thermal conductivity kₚ higher than the thermal conductivity kₛ of the soil.

The soil has air vapor and water vapor mixed therein. The air vapor and the water vapor combine to define a soil heat transfer coefficient hₛ.

The soil is held in position around the length of the pipe 44 by a wrapping material 48 that wraps around the soil along the length L of the pipe 44. In doing so, the wrapping material 48 contains the soil around the pipe 44 and maintains a consistent radial soil annulus width δₛ around the pipe 44. Without the wrapping material 48, the soil would settle or otherwise move thereby creating an inconsistent radial soil annulus width δₛ around the pipe 44. The wrapping material 48 can be any of the civil engineering fabrics known in the art.

The optimum radial soil annulus width δₛ is equal to the peripheral radius r_{∞} minus the outside radius rₒ, i.e., δₛ=r_{∞}−rₒ. The optimum value of the peripheral radius r_{∞} from the standpoint of heat dissipation is given by the relation

$${r}_{∞} = \frac{{k}_{s}}{{h}_{s}} .$$

It is noted that the optimum value of the peripheral radius r_{∞} is independent of the inside radius rᵢ and the outside radius rₒ. Substituting

$$\frac{{k}_{s}}{{h}_{s}}$$

for r_{∞}, the optimum radial soil annulus width δₛ is equal to

$$\frac{{k}_{s}}{{h}_{s}} - {r}_{o} .$$

In operation, the pipe 44 can be buried by digging an appropriate trench, laying the flat wrapping material 48 at the bottom of the trench, filling the soil on top of the wrapping material 48 so as to achieve the proper radial soil annulus width δₛ around the bottom half of the pipe 44, laying the pipe 44 in the soil, filling the soil on top of the pipe 44 so as to achieve the proper radial soil annulus width δₛ around the top half of the pipe 44, wrapping the wrapping material 48 around the pipe 44, and securing the wrapping material 48 in place.

The optimal length L of the pipe 44 is given by the equation

$$L == \frac{{mc}_{p}}{2 π} \{ \frac{0.5469}{{k}_{f}} + \frac{1}{{k}_{p}} ln ( \frac{{r}_{o}}{{r}_{i}} ) + \frac{1}{{k}_{s}} [ 1 + ln ( \frac{{r}_{∞}}{{r}_{o}} ) ] \}$$

$$wherein$$

$${r}_{∞} = \frac{{k}_{s}}{{h}_{s}} .$$

The optimal depth D at which the pipe 44 is buried in the ground is given by the equation

$$D = {r}_{o} ( \sqrt{{α}^{2} - α + 1} - α ) wherein α = exp [ \frac{2 π {k}_{p} L}{{mc}_{p}} - ln ( \frac{{r}_{o}}{{r}_{i}} ) ] .$$

This optimal depth D is where the temperature of the ground is lowest year round. As such, the optimal depth D will yield the most effective cooling of the coolant conveyed by the pipe 44. As an example, the optimum depth D at which the pipe 44 can be buried is approximately six feet.

This optimum depth D of a geocooling system differs from that of a geoheating system. In a geoheating system, it is desirable to utilize ground having a higher temperature. Typically, the geothermal temperature gradient of the ground is such that the temperature of the ground increases as depth increases. Therefore, a heat transfer device of a geoheating system would be buried much deeper in the ground than the pipe 44 of the invention. More specifically, the heat transfer device of a geoheating system would be buried twenty feet below the surface of the ground. Further, the heat transfer device of a geoheating system would be buried in a vertical orientation.

Alternatively, the pipe 44 can have a cross section that is in the shape of a star, as is shown in FIG. 4. As such, the surface area of the pipe 44 is increased thereby increasing heat dissipation from the coolant to the soil. The wrapping material 48 can contain the soil around the pipe 44 to maintain the radial soil annulus width δₛ around the star shaped pipe 44. In this case, the soil annulus width δₛ would extend radially from the outside of the star shaped pipe 44 to the peripheral radius r_{∞}. Accordingly, a formula could be developed to relate the radial soil annulus width δₛ, the length L, and depth D, to the dimensions of this, or another, cross section to thereby optimize the radial soil annulus width δₛ, length L, and depth D.

In the first variation, the working fluid, i.e., the fluid being cooled by the cooling loop 20 (in this case, the second refrigerant), is heated indirectly via the first heat exchanger 30. Put another way, the second refrigerant is not directly heated by the solar collectors 28. The use of the first heat exchanger 30 to heat the second refrigerant is beneficial because it reduces the total inventory of refrigerant in the system.

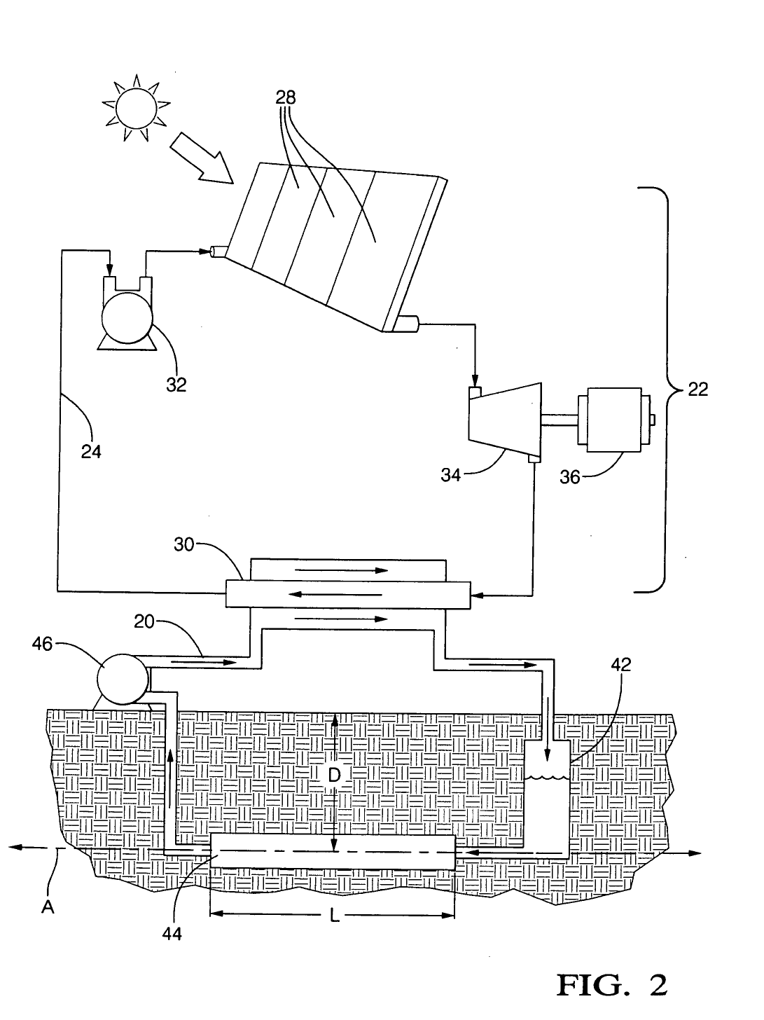

As shown in FIG. 2, an alternative second variation can have a system that comprises a heating sub system 22 having only a heating loop 24, i.e., no power generating loop 26, and a cooling loop 20. In this variation, the working fluid, i.e., the fluid being cooled by the cooling loop 20, is heated directly by the solar collectors 28.

The heating loop 24 circulates a first refrigerant therearound and includes a plurality of solar collectors 28, a turbine 34, a generator 36, a first heat exchanger 30, and a first refrigerant pump 32. The solar collectors 28 collect thermal energy generated by the sun. The first refrigerant passes through the solar collectors 28 and absorbs the thermal energy. As a result the thermal energy evaporates the first refrigerant in liquid form into a vapor form of the first refrigerant. At this point, the vapor form of the first refrigerant has a first high pressure. As an example, the first refrigerant can be R-134a.

The turbine 34 receives and expands the first high pressure vapor form of the first refrigerant. In doing so, mechanical work is produced. A generator 36 is coupled to the turbine 34 for generating electrical power from the mechanical work produced by the turbine 34.

The first heat exchanger 30 receives the expanded first refrigerant from the turbine 34 and removes thermal energy therefrom. In doing so, the expanded first refrigerant is condensed thereby producing the second refrigerant in liquid form, which is then pumped back to the solar collectors 28 via the first refrigerant pump 32 to complete the heating loop 24.

The cooling loop 20 circulates a coolant, in liquid form, through the first heat exchanger 30 in a cross current fashion with and in heat transfer relationship to the expanded first refrigerant. As a result, thermal energy from the expanded first refrigerant is transferred to the coolant thereby heating the coolant, which produces heated coolant in liquid form. The coolant has thermal conductivity k_{f} and an isobaric specific heat cₚ. The coolant is circulated at a mass flow rate m.

The cooling loop 20 includes the plenum 42, the pipe 44, and the coolant pump 46. The plenum 42 receives and stores the heated coolant from the first heat exchanger 30. The pipe 44 has an axis A, a length L, and a circular cross section with an outside radius rₒ and an inside radius rᵢ as shown in FIG. 3. The outside radius rₒ is measured radially from the axis A to the outer edge of the pipe 44 and the inside radius rᵢ is measured radially from the axis A to the inner edge of the pipe 44. The outside radius rₒ and the inside radius rᵢ differ by the thickness of the pipe 44. The pipe 44 removes thermal energy from the heated coolant from the plenum 42 and dissipates it into the ground. In doing so, the coolant is cooled thereby producing cooled coolant in liquid form, which is then pumped back to the first heat exchanger 30 via coolant pump 46 to complete the cooling loop 20.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system for generating electric power comprising;
a heating sub system disposed above the ground for generating thermal energy and for circulating at least one fluid to convey thermal energy generated by said heating sub system,
a cooling loop for circulating a coolant having a thermal conductivity (k_{f}) and an isobaric specific heat (cₚ) therethrough at a mass flow rate m and for removing the thermal energy from the fluid including a pipe having an axis and a length (L) and a cross section for dissipating thermal energy into the ground,
said pipe disposed in a horizontal orientation buried in the ground at depth (D),
a soil surrounding said length (L) of said pipe and having a thermal conductivity (kₛ),
said pipe being made of a material having a thermal conductivity (kₚ) less than the thermal conductivity (kₛ) of said soil,
said soil having air vapor and water vapor mixed therein with said air vapor and said water vapor combining to define a soil heat transfer coefficient (hₛ), and
a wrapping material wrapped around said soil surrounding said length L of said pipe for defining and maintaining a radial soil annulus having a width (δₛ) around said pipe extending radially from said pipe to an outer periphery at a peripheral radius (r_{∞}) measured radially from said axis (A).

2. A system as set forth in claim 1 wherein said cross section of said pipe is circular with said circular cross section having an outside radius (rₒ) and an inside radius (rᵢ) with said radial soil annulus width (δₛ) extending radially from said outside radius (rₒ) of said pipe to said outer periphery.

3. A system as set forth in claim 1 wherein said cross section of said pipe is in the shape of a star.

4. A system as set forth in claim 2 wherein said radial soil annulus width (δₛ) is equal to
$$\frac{{k}_{s}}{{h}_{s}} - {r}_{o} .$$

5. A system as set forth in claim 2 wherein said length
$$L = \frac{{mc}_{p}}{2 π} \{ \frac{0.5469}{{k}_{f}} + \frac{1}{{k}_{p}} ln ( \frac{{r}_{o}}{{r}_{i}} ) + \frac{1}{{k}_{s}} [ 1 + ln ( \frac{{r}_{∞}}{{r}_{o}} ) ] \}$$
$$wherein$$
$${r}_{∞} = \frac{{k}_{s}}{{h}_{s}} .$$

6. A system as set forth in claim 5 wherein said depth
$$D = {r}_{o} ( \sqrt{{α}^{2} - α + 1} - α ) wherein α = exp [ \frac{2 π {k}_{p} L}{{mc}_{p}} - ln ( \frac{{r}_{o}}{{r}_{i}} ) ] .$$

7. A system as set forth in claim 6 wherein said heating sub system includes a heating loop for circulating a first refrigerant having a plurality of solar collectors for collecting thermal energy generated by the sun to evaporate the first refrigerant in liquid form into a vapor form of the first refrigerant having a first high pressure and a first heat exchanger in communication with said solar collectors for removing thermal energy from the vapor form of the first refrigerant to condense the vapor form of the first refrigerant to produce the first refrigerant in liquid form and a first refrigerant pump for pumping the liquid form of the first refrigerant from said first heat exchanger to said solar collectors.

8. A system as set forth in claim 7 wherein said heating sub system includes a power generating loop for circulating a second refrigerant in liquid form through said first heat exchanger in a cross current fashion with and in heat transfer relationship to the vapor form of the first refrigerant for transferring thermal energy from the vapor form of the first refrigerant to vaporize the second refrigerant to produce a vapor form of the second refrigerant having a second high pressure and having a turbine for receiving and expanding the second high pressure vapor form of the second refrigerant to produce mechanical work and a generator coupled to said turbine for generating electrical power from the mechanical work produced by said turbine and a second heat exchanger receiving the expanded second refrigerant from said turbine for removing thermal energy from the expanded second refrigerant to condense the expanded second refrigerant to produce the liquid second refrigerant and a second refrigerant pump for pumping the second refrigerant in said power generating loop from said second heat exchanger to said first heat exchanger.

9. A system as set forth in claim 8 wherein said cooling loop circulates the coolant in liquid form through said second heat exchanger in a cross current fashion with and in heat transfer relationship to the vapor form of the expanded second refrigerant for extracting thermal energy from the expanded second refrigerant to heat the coolant to produce heated coolant in liquid form and has a plenum for receiving and storing the heated coolant and for feeding the heated coolant to said pipe and a coolant pump for pumping the coolant in said cooling loop from said pipe to said second heat exchanger.

10. A system as set forth in claim 1 wherein said heating sub system includes a heating loop for circulating a first refrigerant having a plurality of solar collectors for collecting thermal energy generated by the sun to evaporate the first refrigerant in liquid form into a vapor form of the first refrigerant having a first high pressure and a turbine for receiving and expanding the first high pressure vapor form of the first refrigerant to produce mechanical work and a generator coupled to said turbine for generating electrical power from the mechanical work produced by said turbine and a first heat exchanger in communication with said turbine for removing thermal energy from the vapor form of the expanded first refrigerant to condense the vapor form of the expanded first refrigerant to produce the first refrigerant in liquid form and a first refrigerant pump for pumping the liquid form of the first refrigerant from said first heat exchanger to said solar collectors.

11. A system as set forth in claim 10 wherein said cooling loop circulates the coolant in liquid form through said first heat exchanger in a cross current fashion with and in heat transfer relationship to the vapor form of the expanded first refrigerant for extracting thermal energy from the expanded first refrigerant to heat the coolant to produce heated coolant in liquid form and has a plenum for receiving and storing the heated coolant and for feeding the heated coolant to said pipe and a coolant pump for pumping the coolant in said cooling loop from said pipe to said first heat exchanger.

12. A system for generating electric power comprising;
a heating sub system disposed above the ground and including a heating loop for circulating a first refrigerant having a plurality of solar collectors for collecting thermal energy generated by the sun to evaporate the first refrigerant in liquid form into a vapor form of the first refrigerant having a first high pressure and a first heat exchanger in communication with said solar collectors for removing thermal energy from the vapor form of the first refrigerant to condense the vapor form of the first refrigerant to produce the first refrigerant in liquid form and a first refrigerant pump for pumping the liquid form of the first refrigerant from said first heat exchanger to said solar collectors,
said heating sub system including a power generating loop for circulating a second refrigerant in liquid form through said first heat exchanger in a cross current fashion with and in heat transfer relationship to the vapor form of the first refrigerant for transferring thermal energy from the vapor form of the first refrigerant to vaporize the second refrigerant to produce a vapor form of the second refrigerant having a second high pressure and having a turbine for receiving and expanding the second high pressure vapor form of the second refrigerant to produce mechanical work and a generator coupled to said turbine for generating electrical power from the mechanical work produced by said turbine and a second heat exchanger receiving the expanded second refrigerant from said turbine for removing thermal energy from the expanded second refrigerant to condense the expanded second refrigerant to produce the liquid second refrigerant and a second refrigerant pump for pumping the second refrigerant in said power generating loop from said second heat exchanger to said first heat exchanger,
a cooling loop for circulating a coolant in liquid form having a thermal conductivity (k_{f}) and an isobaric specific heat (cₚ) and at a mass flow rate (m) through said second heat exchanger in a cross current fashion with and in heat transfer relationship to the vapor form of the expanded second refrigerant for extracting thermal energy from the expanded second refrigerant to heat the coolant to produce heated coolant in liquid form and including a plenum for receiving and storing the heated coolant and a pipe having an axis and a length (L) and a circular cross section with an outside radius (rₒ) and an inside radius (rᵢ) for removing and dissipating thermal energy from the heated coolant from said plenum into the ground to produce cooled coolant in liquid form and a coolant pump for pumping the coolant in said cooling loop from said pipe to said second heat exchanger,
said pipe disposed in a horizontal orientation buried in the ground at depth (D),
a soil surrounding said length (L) of said pipe and having a thermal conductivity kₛ,
said pipe being made of a material having a thermal conductivity (kₚ) less than the thermal conductivity (kₛ) of said soil,
said soil having air vapor and water vapor mixed therein with said air vapor and said water vapor combining to define a soil heat transfer coefficient (hₛ),
a wrapping material wrapped around said soil surrounding said length L of said pipe for defining and maintaining a radial soil annulus having a width (δₛ) around said pipe extending radially from said pipe to an outer periphery at a peripheral radius (r_{∞}) measured radially from said axis (A),
said radial soil annulus width
$$( {δ}_{s} ) = \frac{{k}_{s}}{{h}_{s}} - {r}_{o} ,$$
said length
$$L = \frac{{mc}_{p}}{2 π} \{ \frac{0.5469}{{k}_{f}} + \frac{1}{{k}_{p}} ln ( \frac{{r}_{o}}{{r}_{i}} ) + \frac{1}{{k}_{s}} [ 1 + ln ( \frac{{r}_{∞}}{{r}_{o}} ) ] \}$$
$$wherein$$
$${r}_{∞} = \frac{{k}_{s}}{{h}_{s}} ,$$
and
said depth
$$D = {r}_{o} ( \sqrt{{α}^{2} - α + 1} - α ) wherein α = exp [ \frac{2 π {k}_{p} L}{{mc}_{p}} - ln ( \frac{{r}_{o}}{{r}_{i}} ) ] .$$
